(19) United States
(12) Patent Application Publication
(10) Pub. No.: US 2014/0291298 A1
(43) Pub. Date: Oct. 2, 2014

(54) METHOD OF WELDING PLATED STEEL SHEET AND RAW STEEL SHEET AND METHOD OF WELDING VEHICLE DOOR SASH

(71) Applicant: Shiroki Corporation, Kanagawa (JP)

(72) Inventors: Jiro YOSHIHARA, Kanagawa (JP); Isami MITUHASHI, Kanagawa (JP)

(73) Assignee: SHIROKI CORPORATION, Kanagawa (JP)

(21) Appl. No.: 14/225,468

(22) Filed: Mar. 26, 2014

(30) Foreign Application Priority Data
Mar. 29, 2013 (JP) 2013-071186
Mar. 14, 2014 (JP) 2014-051051

(51) Int. Cl. B23K 11/00; B23K 11/11

(52) U.S. Cl. CPC B23K 11/002; B23K 11/115
USPC 219/78.01

(57) ABSTRACT

A method of spot-welding portions of a plated steel sheet and a raw steel sheet which are overlaid on each other, the spot-welding method includes preparing a flat electrode and a radius electrode serving as a pair of welding electrodes, bringing the flat electrode and the radius electrode into contact with the portions of the plated steel sheet and the raw steel sheet, respectively, with the portions of the plated steel sheet and the raw steel sheet overlaid on each other, and performing a spot-welding process by passing a welding current through the flat electrode and the radius electrode to spot-weld the portions of the plated steel sheet and the raw steel sheet to each other while applying pressure on the portions of the plated steel sheet and the raw steel sheet by the flat electrode and the radius electrode.

### BACKGROUND OF THE INVENTION

1. Field of the Invention

The present invention relates to a method of welding a plated (galvanized) steel sheet and a raw steel sheet, and a method of welding a vehicle door sash.

2. Description of Related Art

For instance, vertical-pillar sash members of a vehicle door sash are made by joining steel sheets together. As examples of such steel sheets, in the related art, raw (non-plated) steel sheets (generally cold-rolled steel sheets (JIS-SPCC)) have been used, and are joined by spot welding (resistance welding). Spot welding is a process in which overlapping raw steel sheets are clamped by a pair of radius electrodes and welded under pressure exerted thereby while being supplied with a welding current.

On the other hand, in vertical-pillar sash members, in order to prevent corrosion, it has been attempted to adopt a plated (zinc-plated/galvanized) steel sheet as one of the two steel sheets which are welded together (Japanese Unexamined Patent Publication No. 2008-290129).

However, if a plated steel sheet and a raw steel sheet are clamped and joined by welding by a pair of radius electrodes, plating on the surface of the plated steel sheet is deposited on the radius electrodes to thereby considerably impair the durability of the radius electrodes. The cause of this has been considered to be attributed to the fact that vaporization of zinc on the plated steel sheet (occurrence of zinc vapor) causes the plating material (zinc) on the plated steel sheet to be deposited on the radius electrodes, which are made of, e.g., chromium-copper (Cu—Cr), chromium-zirconium-copper (Cu—Cr—Zr), beryllium copper (Cu—Be) or aluminum-oxide-dispersion-strengthened copper alloy, thus causing the quality of welding (nugget diameter) to deteriorate as the number of welding points increases.

### SUMMARY OF THE INVENTION

The present invention has been made in view of the problems described above and provides a welding method which does not deteriorate the durability of spot welding electrodes when a plated steel sheet and a raw steel sheet are spot-welded.

The present invention also provides a welding method which similarly does not deteriorate the durability of spot welding electrodes for spot welding on a vertical-pillar sash member for vehicle configured of a plated steel sheet and a raw steel sheet that are joined by spot welding. Specifically, the present invention provides a desirable welding method for a specific configuration in which a glass-run holding depressed portion is partly formed on a spot-welding portion between the plated steel sheet and the raw steel sheet.

The present invention has been accomplished based on the findings that the plating material of the plated steel sheet does not cause the radius electrode to deteriorate if one and the other of the pair of welding electrodes are made as a flat electrode and a radius electrode and if the flat electrode and the radius electrode are respectively brought into contact with the plated steel sheet and the raw steel sheet.

According to an aspect of the present invention, a method of spot-welding portions of a plated steel sheet and a raw steel sheet which are overlaid on each other, the spot-welding method including preparing a flat electrode and a radius electrode serving as a pair of welding electrodes; bringing the flat electrode and the radius electrode into contact with the portions of the plated steel sheet and the raw steel sheet, respectively, with the portions of the plated steel sheet and the raw steel sheet overlaid on each other; and performing a spot-welding process by passing a welding current through the flat electrode and the radius electrode to spot-weld the portions of the plated steel sheet and the raw steel sheet to each other while applying pressure on the portions of the plated steel sheet and the raw steel sheet by the flat electrode and the radius electrode.

According to another aspect of the present invention, a method of spot-welding a vehicle door sash, is provided, in which a pocket-like portion is formed from an inner member and an outer member and in which a spot welding process is performed on plate portions of the inner member and the outer member which are overlaid on each other to close the pocket-like portion, the spot-welding method including preparing the inner member and the outer member which are made of a plated steel sheet and a raw steel sheet, respectively; preparing a flat electrode and a radius electrode serving as a pair of welding electrodes; bringing the flat electrode and the radius electrode into contact with the plate portions of the inner member and the outer member, which are made of the plated steel sheet and the raw steel sheet, respectively, with the portions of the plated steel sheet and the raw steel sheet overlaid on each other; and performing a spot-welding process by passing a welding current through the flat electrode and the radius electrode to spot-weld the plate portions to each other while applying pressure on the plate portions of the plated steel sheet and the raw steel sheet by the flat electrode and the radius electrode.

It is desirable for the following condition is satisfied:

Q≧2 q, wherein “Q” designates a contact area of the flat electrode on the plated steel sheet, and “q” designates a contact area of the radius electrode on the raw steel sheet.

It is desirable for the flat electrode to contact the plated steel sheet without any welding marks being produced on the plated steel sheet during the spot welding process, and for the radius electrode to contact the raw steel sheet while producing welding marks on the raw steel sheet during the spot-welding process.

It is desirable for the thickness of the plated steel sheet to be greater than the thickness of the raw steel sheet.

It is desirable for the inner member to include a design portion which is positioned on a vehicle exterior side, and a folded-back portion which extends from the design portion and bends toward a vehicle interior side, a window opening side and the vehicle exterior side, in that order. The outer member includes a design portion which is positioned on the vehicle exterior side, and a folded-back portion which extends from the design portion of the outer member and bends toward the vehicle interior side, the window opening side and the vehicle exterior side, in that order, wherein ends of the folded-back portions of the inner member and the outer members which extend toward the vehicle exterior side constitute the plate portions, and the end of the plate portion of the outer member on the vehicle exterior side includes a bent portion which bends toward the window opening side.

If the bent portion is formed in this manner, the glass run supported by a part of the welded portion is prevented from being damaged.

It is desirable for the length of the bent portion toward the window opening side to be longer than the thickness of the inner member.

It is desirable for the end portion of the design portion along the window opening side to include a folded-back portion.

It is desirable for he method of spot-welding to include a vehicle-interior-side extension portion which extends from the design portion of the outer member and a vehicle-interior-side extension portion which extends from the design portion of the inner member. The vehicle-interior-side extension portions of the outer member and the inner member constitute the plate portions to be welded by the flat electrode and the radius electrode.

It is desirable for one of the vehicle-interior-side extension portions of the outer member and the inner member to be provided with at least one welding seat which protrudes toward the other of the vehicle-interior-side extension portions of the outer member and the inner member.

According to the present invention, when a plated steel sheet and a raw steel sheet are joined by spot welding, one and the other of the pair of welding electrodes are shaped into a flat electrode and a radius electrode, and in a state where a plated steel sheet and a raw steel sheet are overlaid on each other, the flat electrode and the radius electrode are brought into contact with the plated steel sheet and the raw steel sheet, respectively, to clamp the plated steel sheet and the raw steel sheet therebetween, and spot welding is performed by passing a welding current through the flat electrode and the radius electrode while applying pressure to the plated steel sheet and the raw steel sheet. Namely, the flat electrode having a broader contact area contacts the plated steel sheet, and accordingly, even if the vaporized zinc which is produced from the plated steel sheet is deposited on the flat electrode, the adverse effect of the vaporized zinc will be smaller than in the case where the radius electrode which has a narrower contact area contacts with the plated steel sheet in the art, which makes it possible to improve the durability of the electrode which contacts with the plated steel sheet.

According to the method of welding a vehicle door sash according to the present invention, in a vertical-pillar sash member, for a vehicle, which is configured of a plated sheet-steel inner member and a raw sheet-steel outer member that are joined by spot welding, spot-welding marks created with the radius electrode exist on the overlay plate portion of the outer member and no spot-welding marks exist on the overlay plate portion of the inner member.

The present disclosure relates to subject matter contained in Japanese Patent Application Nos. 2013-071186 (filed on Mar. 29, 2013) and 2014-051051 (filed on Mar. 14, 2014) which are expressly incorporated herein by reference in their entirety.

### BRIEF DESCRIPTION OF THE DRAWINGS

The present invention will be discussed below in detail with reference to the accompanying drawings, in which:

FIG. 1 is a side elevational view of an embodiment of a vehicle door which includes a vertical-pillar sash member to which a method of welding a plated steel sheet and a raw steel sheet according to the present invention is applied;

FIG. 2 is a cross sectional view taken along the line II-II shown in FIG. 1;

FIG. 3 is a cross sectional view showing a state in which an inner member and an outer member, which are made of a plated steel sheet and a raw steel sheet, respectively, are spot-welded with a flat electrode and a radius electrode;

FIG. 4A is a perspective view of an embodiment of the flat electrode shown in FIG. 3; and

FIG. 4B is a perspective view of an embodiment of the radius electrode shown in FIG. 3.

### DESCRIPTION OF THE EMBODIMENT

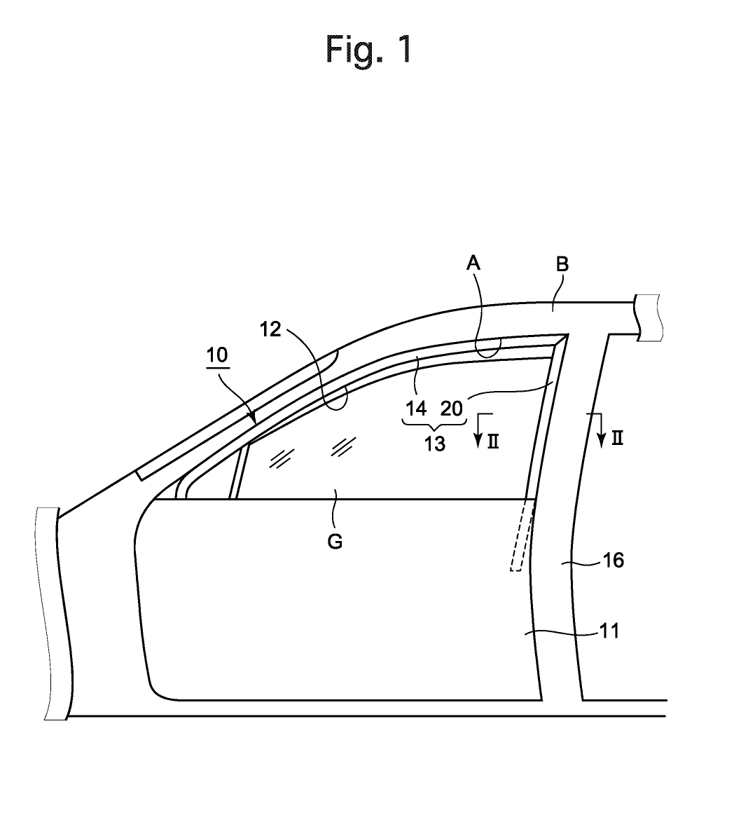

FIG. 1 shows a side elevational view of a side of a motor vehicle including a vehicle door 10. The vehicle door 10 is for opening and closing a door opening (body opening) A of a vehicle body B and is provided with a door body (including of an inner panel and an outer panel) 11 and a door sash (window frame) 13, which forms a window opening 12 on top of the inner panel 11.

The door sash 13 is provided with an upper sash member 14 and a vertical-pillar sash member 20. The upper sash member 14 is formed into a curved shape in a side view to receive the upper edge of a window pane G, and the vertical-pillar sash member 20 extends along a center pillar (B-pillar) 16 of the vehicle body B to receive the vertical edge of the window pane G. The upper end of the vertical-pillar sash member 20 and the rear end of the upper sash member 14 are connected and fixed to each other by a known method, and the lower ends of the vertical-pillar sash member 20 and the upper sash member 14 extend downward into the inside of the door body 11 and are fixed thereto. In the present embodiment of the vehicle door, the present invention has been applied to the vertical-pillar sash member 20 of the door sash 13.

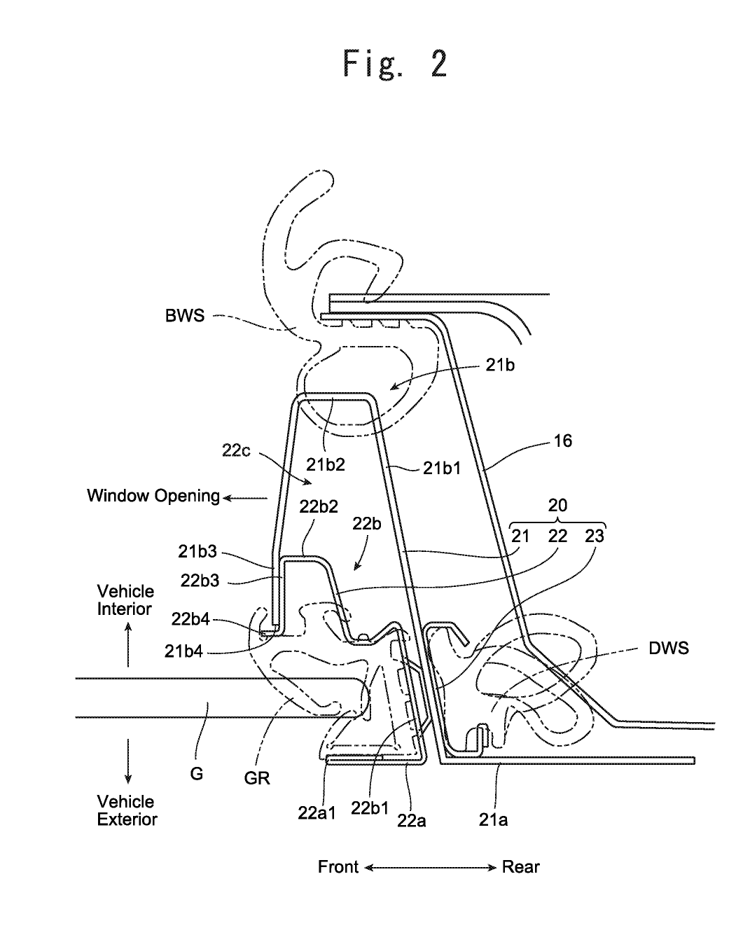

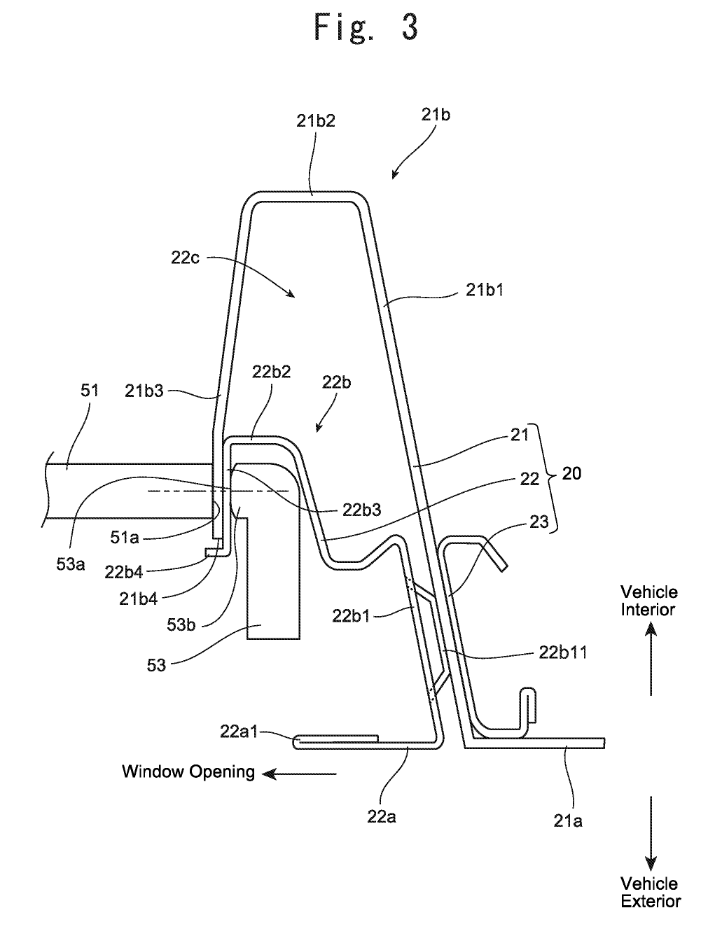

As shown in FIG. 2, the vertical-pillar sash member 20 is provided with an inner (main vertical pillar) member 21, an outer (sub-vertical pillar) member 22 which is positioned closer to the vehicle exterior side (the lower side with respect to FIGS. 2 and 3) than the inner member 21, and a weather strip retaining member 23. Out of these members, the inner member 21 is made of a galvanized steel sheet, while each of the outer member 22 and the weather strip retaining member 23 is made of a raw steel sheet (cold-rolled steel sheet (JIS-SPCC)). The thickness of the inner member (galvanized steel sheet) 21 is greater than the thickness of the outer member (raw steel sheet) 22.

The inner member 21 is provided with a design portion 21a which is positioned on the vehicle exterior side and a folded-back portion 21b which extends from the design portion 21a toward the vehicle interior side (the upper side with respect to FIGS. 2 and 3). The folded-back portion 21b is provided with a vehicle-interior-side extension portion 21b1, a forward/rearward extension portion 21b2 and a vehicle-exterior-side extension portion 21b3. The vehicle-interior-side extension portion 21b1 extends obliquely toward the vehicle interior side from the design portion 21a, the forward/rearward extension portion 21b2 extends toward the window opening 12 side (toward the front of the vehicle/toward the left side with respect to FIGS. 2 and 3) from the end of the vehicle-interior-side extension portion 21b1 on the vehicle interior side, and the vehicle-exterior-side extension portion 21b3 extends toward the vehicle exterior side from the end of the forward/rearward extension portion 21b2 on the window opening 12 side.

The outer member 22 is provided with a design portion 22a which is positioned on the vehicle exterior side and a folded-back portion 22b which extends from the design portion 22a toward the vehicle interior side. The folded-back portion 22b is provided with a vehicle-interior-side extension portion 22b1, a closed-cross-section (pocket-like portion) forming portion 22b2, a vehicle-exterior-side extension portion 22b3 and a bent portion 22b4. The vehicle-interior-side extension portion 22b1 extends obliquely toward the vehicle interior side from the design portion 22a along the vehicle-interior-side extension portion 21b1, the closed-cross-section forming portion 22b2 extends stepwise toward the window opening 12 side from the end of the vehicle-interior-side extension portion 22b1, and the vehicle-exterior-side extension portion 22b3 extends toward the vehicle exterior side from the end of the closed-cross-section forming portion 22b2 on the window opening 12 side along the vehicle-exterior-side extension portion 21b3. The folded-back portion 21b (specifically the vehicle-interior-side extension portion 21b1, the forward/rearward extension portion 21b2 and the vehicle-exterior-side extension portion 21b3) of the inner member 21 and the folded-back portion 22b (specifically the closed-cross-section forming portion 22b2) of the outer member 22 define a pocket-like portion 22c having a closed cross sectional shape. The end portion of the design portion 22 along the window opening side is formed as a folded-back portion (flat hem) 22a1.

The end of the vehicle-exterior-side extension portion 21b3 of the inner member 21 on the vehicle exterior side and the end of the vehicle-exterior-side extension portion 22b3 of the outer member 22 on the vehicle exterior side are overlaid into a plate portion so as to close the pocket-like portion 22c. The vehicle-interior-side extension portion 22b1 of the outer member 22 is provided, at different positions thereon at predetermined intervals in the vertical direction of the vehicle-interior-side extension portion 22b1, with a plurality of welding seats 22b11 which project toward the vehicle interior side from the window opening 12 side. The vehicle-interior-side extension portion 22b1 and the plurality of welding seats 22b11 of the outer member 22, and the vehicle-interior-side extension portion 21b1 of the inner member 21 are overlaid to form a plate portion (a substantially-plate-shaped portion) that closes the pocket-like portion 22c. It is possible to overlay the vehicle-interior-side extension portions 21b1 and 22b1 to form a plate portion without forming the plurality of welding seats 22b 11 on the vehicle-interior-side extension portion 22b1. Alternatively, welding seats can be provided on the vehicle-interior-side extension portions 21b1 of the inner member 21.

The weather strip retaining member 23 is a channel member which retains a door-side weather strip DWS (shown by two-dot chain lines in FIG. 2). The weather strip retaining member 23, the vehicle-interior-side extension portion 21b1 of the inner member 21 and the vehicle-interior-side extension portion 22b1 of the outer member 22 are joined together by welding (e.g., spot welding). The door-side weather strip DWS and a door-side weather strip BWS (shown by two-dot chain lines in FIG. 2) which is supported by the vehicle body B are compressed between the vehicle door 10 and the center pillar 16 of the vehicle body B and between the vehicle door 10 and the vehicle-interior-side extension portion 21b1 of the inner member 21 to prevent rain water from entering the vehicle body B when the vehicle door 10 is closed.

The design portion 22a and the folded-back portion 22b of the outer member 22 constitute a glass-run holding recess which holds a glass run GR. The glass run GR guides a window pane G for opening and closing the window opening 12 as known in the art. The end of the outer member 22 on the vehicle exterior side adjacent to the vehicle-exterior-side extension portion 22b3 is formed as a bent portion 22b4. The end (trim edge) 21b4 of the vehicle-exterior-side extension portion 21b3 of the inner member 21 on the vehicle exterior side faces the surface of the bent portion 22b4 on the vehicle interior side. When the window pane G is driven to move up and down to close and open the window opening 12, force in the vehicle width direction is exerted on the glass run GR. The bent portion 22b4 of the folded-back portion 22b receives this force to prevent the glass run GR from being damaged.

The design portion 21a of the inner member 21 and the design portion 22a of the outer member 22 are substantially flush with each other, and a garnish (not shown) is mounted to the flush outer surfaces (lower surfaces with respect to FIGS. 2 and 3) of the design portion 21a and the design portion 22a.

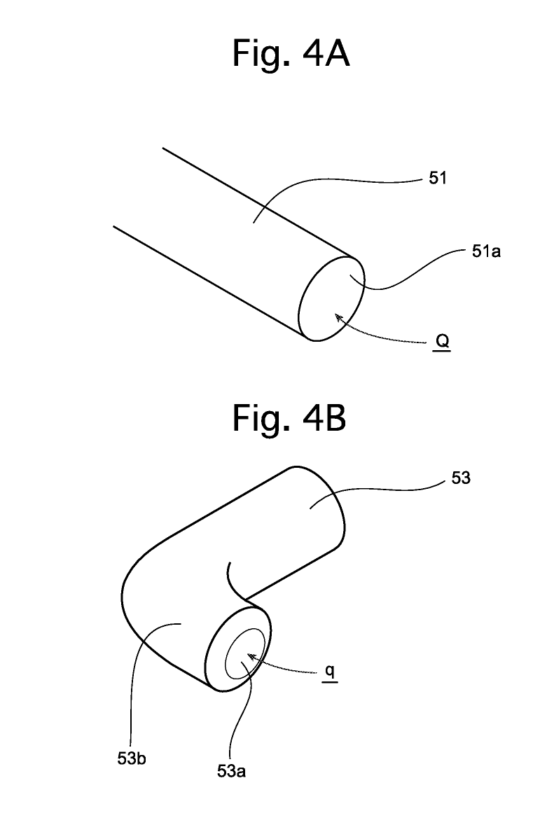

In the present embodiment of the vehicle door, the vehicle-exterior-side extension portion 21b3 of the inner member 21, which is made of a plated steel sheet, and the vehicle-exterior-side extension portion 22b3 of the outer member 22, which is made of a raw steel sheet, are joined by spot welding using a flat electrode 51 and a radius electrode 53 (shown in FIGS. 3, 4A and 4B). The vehicle-interior-side extension portion 21b1 of the inner member 21 and the plurality of welding seats 22b11 of the outer member 22 can also be joined by spot welding using the flat electrode 51 and the radius electrode 53. The weather strip retaining member 23 is welded to the vehicle-interior-side extension portion 22b1 of the outer member 22 after the vehicle-interior-side extension portion 21b1 and the plurality of welding seats 22b11 are welded.

The spot-welding process using the flat electrode 51 and the radius electrode 53 with the vehicle-exterior-side extension portion 21b3 of the inner member 21 and the vehicle-exterior-side extension portion 22b3 of the outer member 22 being overlaid on each other will be discussed hereinafter, as an example. However, the vehicle-interior-side extension portion 21b1 of the outer member 21 and the plurality of welding seats 22b11 of the outer member 22 can also be welded by a similar welding process using the flat electrode 51 and the radius electrode 53.

The vehicle-exterior-side extension portion 21b3 of the inner member 21, which is made of a plated steel sheet, and the vehicle-exterior-side extension portion 22b3 of the outer member 22, which is made of a raw steel sheet, are overlaid on each other. The vehicle-exterior-side extension portion 21b3 of the inner member 21, which is made of a plated steel sheet, and the vehicle-exterior-side extension portion 22b3 of the outer member 22, which is made of a raw steel sheet, which have been overlaid on each other in a different process is prepared (brought in).

The flat electrode 51 that serves as a welding electrode on the current reception side and the radius electrode 53 that serves as a welding electrode on the current supply side are prepared as spot welding electrodes. The end of the flat electrode 51 is circular in cross section, and the end of the flat electrode 51 which comes into contact with a steel sheet is formed as a flat electrode surface 51a (see FIG. 4A). The radius electrode 53 has a circular cross section, and the diameter of the radius electrode 53 gradually reduces toward the end thereof (the end that comes in contact with the steel sheet). The radius electrode 53 is, in this embodiment, provided at the end thereof with an bent-end portion 53b which is bent at an angle of 90 degrees, and a small electrode surface 53a which comes into contact with a steel sheet is formed at the end surface of the bent-end portion 53b (see FIG. 4A). The area of the small electrode surface 53a is smaller than the area of the flat electrode surface 51a. The small electrode surface 53a can be formed into a flat surface or a curved (convex) surface. Each of the flat electrode 51 and the radius electrode 53 is made of, e.g., chromium-copper (Cu—Cr), chromium-zirconium-copper (Cu—Cr—Zr), beryllium copper (Cu—Be) or aluminum-oxide-dispersion-strengthened copper alloy.

When the contact area of the flat electrode 51 with the inner member (plated steel sheet) 21 (namely area of the flat electrode surface 51a) and contact area of the radius electrode 53 with the outer member (raw steel sheet) 22 (namely area of the small electrode surface 53a) are defined as “Q” and “q”, respectively, the relationship “Q>q” is satisfied. The area “Q” and “q” are determined with consideration of the thickness of the steel sheets 21 and 22, however, it is desirable for the relationship Q≧2 q to be satisfied regardless of the thickness of the steel sheets 21 and 22.

In other words, the flat electrode 51 is defined as the electrode which contacts the plated steel sheet 21 with no welding mark being produced on the plated steel sheet during the spot welding process, and the radius electrode 53 is defined as the electrode which contacts the raw steel sheet 22 with a welding mark being produced on the raw steel sheet during the spot welding process.

The flat electrode surface 51a of the flat electrode is brought into contact with the vehicle-exterior-side extension portion 21b3 of the inner member 21, which is made of a plated steel sheet, and the small electrode surface 53a of the radius electrode 53 is brought into contact with the vehicle-exterior-side extension portion 22b3 of the outer member 22, which is made of a raw steel sheet, so as to be opposed to the flat electrode surface 51a with the vehicle-exterior-side extension portions 21b3 and 22b3 positioned between the flat electrode surface 51a and the small electrode surface 53a (see FIG. 3). It does not matter whether the flat electrode surface 51a or the small electrode surface 53a is first brought into contact with the associated vehicle-exterior-side extension portion 21b3 or 22b3.

The vehicle-exterior-side extension portions 21b3 and 22b3 are clamped by the flat electrode 51 and the radius electrode 53, and are spot-welded by passing a welding current (direct current) through the flat electrode 51 and the radius electrode 53 while applying pressure to the vehicle-exterior-side extension portions 21b3 and 22b3 by the flat electrode 51 and the radius electrode 53. Welding current can be supplied either from the flat electrode 51 to the radius electrode 53 or from the radius electrode 51 to the flat electrode 53.

The above-described spot welding process using the flat electrode 51 and the radius electrode 53 is performed at different points in the longitudinal direction (vertical direction) of the vehicle-exterior-side extension portions 21b3 and 22b3, which are overlaid on each other.

In the spot welding process described above, the flat electrode plate 51a of the flat electrode 51 contacts the vehicle-exterior-side extension portion 21b3, which is made of a plated steel sheet, and the small electrode surface 53a of the radius electrode 53 contacts the vehicle-exterior-side extension portion 22b3, which is made of a raw steel sheet, respectively. Accordingly, vaporized zinc which is produced from the plated (galvanized) steel sheet is deposited on the flat electrode 51. However, since the contact area of the flat electrode surface 51a of the flat electrode 51 with the plated steel sheet is broader than the contact area of the small electrode surface of the radius electrode in the conventional art, vaporized zinc which is produced from the plated (galvanized) steel sheet does not exert an adverse effect on the flat electrode 51, making it possible to improve the durability thereof. On the other hand, since the small electrode surface 53a of the radius electrode 53 contacts with the raw steel sheet during the welding process, theoretically no adverse effect is applied to the radius electrode 53.

In the aforementioned embodiment, the radius electrode 53 is provided, at the end of the bent-end portion 53b that is bent at a substantially right angle, with the small electrode surface 53a. However, the present invention is not limited to this particular embodiment. For instance, the bent-end portion 53b can be omitted from the radius electrode 53; namely, the radius electrode 53 can be shaped into a straight rod and provided at the end of this straight rod with the small electrode surface 53a. The small electrode surface 53a can be flat or curved in surface shape so long as the area thereof is smaller than the area of the flat electrode surface 51a. In addition, the radius electrode 53 can be modified such that a small electrode surface corresponding to the small electrode surface 53a is formed on an electrode member that is different from the body of the radius electrode and that this different electrode member that includes the small electrode surface is fixed to the body of the radius electrode by being embedded therein or by being grafted thereto.

Welding marks created by the above described spot-welding process remain on the surface of the vehicle-exterior-side extension portion 22b3 of the outer member 22, with which the radius electrode 53 has been brought into contact, and no welding marks are formed on the surface of the vehicle-exterior-side extension portion 21b3 of the inner surface 21, with which the flat electrode 51 have been brought into contact. The welding marks are formed on the inner surface of the glass-run holding portion, thus not being exposed outwardly. The joint between the vehicle-exterior-side extension portion 21b3 and the vehicle-exterior-side extension portion 22b3, together with the bent portion 24b4, can be hidden by the glass run GR.

The method of welding a plated steel sheet and a raw steel sheet according to the present embodiment has been applied to a vertical-pillar sash member for vehicle which is configured of the plated sheet-steel inner member 21 and the raw sheet-steel outer member 22 that are joined by spot welding, wherein spot-welding marks created with the radius electrode 53 exist on the overlaid plate portion (the vehicle-exterior-side extension portion 22b3) of the outer member 22 and no spot-welding marks exist on the overlaid plate portion (the vehicle-exterior-side extension portion 21b3) of the inner member 21. The sheet edge of the folded-back portion of an outer member (which corresponds to the outer member 22) which sheet edge extends toward the vehicle exterior side has been pre-rolled over itself (i.e., hemmed) by a hemming process, and hence, the present invention achieves a hem-less vertical pillar sash member through the use of spot welding instead of the aforementioned hemming process.

It is desirable for the vehicle exterior side edge of the plate portion of the folded-back portion 22b of the outer member 22, which extends toward the vehicle exterior side, to be provided with the bent portion 22b4 that bends toward the window opening 12 side; moreover, it is desirable for the bent portion 22b4 to be formed having a length greater than the wall thickness of the vehicle-exterior-side extension portion 21b3 of the inner member 21. If the bent portion 22b4 is formed in this manner, the glass run GR is prevented from being damaged by the edge of the vehicle-exterior-side extension portion 22b3.

Although the present invention has been applied to spot welding on an outer member which includes an inner member and an outer member respectively made of a plated steel sheet and a raw steel sheet in the above illustrated embodiment of the vehicle door, the present invention can be applied to spot welding for joining a plated steel sheet and a raw steel sheet in general. A flat electrode and a radius electrode are prepared in advance as a pair of welding electrodes, and in a state where a plated steel sheet and a raw steel sheet are overlaid on each other, the flat electrode and the radius electrode are brought into contact with the plated steel sheet and the raw steel sheet, respectively, to clamp the plated steel sheet and the raw steel sheet therebetween, and spot welding is performed by passing a welding current through the flat electrode and the radius electrode while applying pressure to the plated steel sheet and the raw steel sheet by the flat electrode and the radius electrode.

Obvious changes may be made in the specific embodiment of the present invention described herein, such modifications being within the spirit and scope of the invention claimed. It is indicated that all matter contained herein is illustrative and does not limit the scope of the present invention.

The entire disclosures of all applications, patents and publications, cited herein and of corresponding Japanese Patent Application No. 2013-071186, filed Mar. 29, 2013 and Japanese Patent Application No. 2014-051051, filed Mar. 14, 2014 are incorporated by reference herein.

1. A method of spot-welding portions of a plated steel sheet and a raw steel sheet which are overlaid on each other, said spot-welding method comprising:
preparing a flat electrode and a radius electrode serving as a pair of welding electrodes;
bringing said flat electrode and said radius electrode into contact with said portions of said plated steel sheet and said raw steel sheet, respectively, with said portions of said plated steel sheet and said raw steel sheet overlaid on each other; and
performing a spot-welding process by passing a welding current through said flat electrode and said radius electrode to spot-weld said portions of said plated steel sheet and said raw steel sheet to each other while applying pressure on said portions of said plated steel sheet and said raw steel sheet by said flat electrode and said radius electrode.

2. The method of spot-welding according to claim 1, wherein the following condition is satisfied:
Q≧2 q, wherein
“Q” designates a contact area of the flat electrode on the plated steel sheet, and
“q” designates a contact area of the radius electrode on the raw steel sheet.

3. The method of spot-welding according to claim 1, wherein said flat electrode contacts said plated steel sheet without any welding marks being produced on the plated steel sheet during said spot welding process, and
wherein the radius electrode contacts said raw steel sheet while producing welding marks on said raw steel sheet during said spot-welding process.

4. The method of spot-welding according to claim 1, wherein the thickness of said plated steel sheet is greater than the thickness of said raw steel sheet.

5. A method of spot-welding a vehicle door sash in which a pocket-like portion is formed from an inner member and an outer member and in which a spot welding process is performed on plate portions of said inner member and said outer member which are overlaid on each other to close said pocket-like portion, said spot-welding method comprising:
preparing said inner member and said outer member which are made of a plated steel sheet and a raw steel sheet, respectively;
preparing a flat electrode and a radius electrode serving as a pair of welding electrodes;
bringing said flat electrode and said radius electrode into contact with said plate portions of said inner member and said outer member, which are made of said plated steel sheet and said raw steel sheet, respectively, with said portions of said plated steel sheet and said raw steel sheet overlaid on each other; and
performing a spot-welding process by passing a welding current through said flat electrode and said radius electrode to spot-weld said plate portions to each other while applying pressure on said plate portions of said plated steel sheet and said raw steel sheet by said flat electrode and said radius electrode.

6. The method of spot-welding according to claim 5, wherein the following condition is satisfied.
Q≧2 q
wherein
“Q” designates “contact area of the flat electrode with the plated steel sheet”, and
“q” designates “contact area of the radius electrode with the raw steel sheet.

7. The method of spot-welding according to claim 5, wherein the flat electrode contacts said plated steel sheet without any welding marks being produced on the plated steel sheet during the spot welding process, and
wherein the radius electrode contacts said raw steel sheet while producing welding marks on said raw steel sheet during said spot-welding process.

8. The method of spot-welding according to claim 5, wherein the thickness of said plated steel sheet is greater than the thickness of said raw steel sheet.

9. The method of spot-welding according to claim 5, wherein said inner member comprises:
a design portion which is positioned on a vehicle exterior side; and
a folded-back portion which extends from said design portion and bends toward a vehicle interior side, a window opening side and said vehicle exterior side, in that order,
wherein said outer member comprises:
a design portion which is positioned on said vehicle exterior side; and
a folded-back portion which extends from said design portion of said outer member and bends toward said vehicle interior side, said window opening side and said vehicle exterior side, in that order,
wherein ends of said folded-back portions of said inner member and said outer members which extend toward said vehicle exterior side constitute said plate portions, and
wherein said end of said plate portion of said outer member on said vehicle exterior side includes a bent portion which bends toward said window opening side.

10. The method of spot-welding according to claim 9, wherein the length of said bent portion toward said window opening side is longer than the thickness of said inner member.

11. The method of spot-welding according to claim 9, wherein the end portion of the design portion along the window opening side comprises flat hem.

12. The method of spot-welding according to claim 9, further comprising a vehicle-interior-side extension portion which extends from said design portion of said outer member and a vehicle-interior-side extension portion which extends from said design portion of said inner member, and
wherein said vehicle-interior-side extension portions of said outer member and said inner member constitute said plate portions to be welded by said flat electrode and said radius electrode.

13. The method of spot-welding according to claim 12, wherein one of said vehicle-interior-side extension portions of said outer member and said inner member is provided with at least one welding seat which protrudes toward the other of said vehicle-interior-side extension portions of said outer member and said inner member.
